(19) United States
(12) Patent Application Publication
(10) Pub. No.: US 2005/0225655 A1
(43) Pub. Date: Oct. 13, 2005

(54) Solid-state color image pickup apparatus with a wide dynamic range, and digital camera on which the solid-state image pickup apparatus is mounted

(75) Inventor: Nobuo Suzuki, Kurokawa-gun (JP)

Correspondence Address: BIRCH STEWART KOLASCH & BIRCH, PO BOX 747, FALLS CHURCH, VA, 22040-0747, US

(73) Assignee: Fuji Photo Film Co., Ltd.

(21) Appl. No.: 11/091,770

(22) Filed: Mar. 29, 2005

(30) Foreign Application Priority Data
Mar. 30, 2004 (JP) P. 2004-097815

(51) Int. Cl. H04N 5/217

(52) U.S. Cl. 348/272

(57) ABSTRACT

A solid-state color image pickup apparatus comprises a plurality of pixels, wherein said plurality of pixels are arranged to form an array pattern comprising a first checkered pattern and a second checkered pattern, wherein each of said plurality of pixels detects colors signals of red, green, and blue, and wherein said plurality of pixels comprises: higher-sensitivity pixels forming the first checkered pattern; and lower-sensitivity pixels forming the second checkered pattern.

### BACKGROUND OF THE INVENTION

1. Field of the Invention

The present invention relates to a solid-state color image pickup apparatus with a wide dynamic range, and a digital camera on which the solid-state image pickup apparatus is mounted.

2. Description of the Related Art

In a CCD solid-state image pickup apparatus or a CMOS solid-state image pickup apparatus which is mounted on a digital camera, a large number of photoelectric converting elements (photodiodes) serving as light receiving portions, and signal read circuits which read out photoelectric conversion signals obtained in the photoelectric converting elements are formed on the surface of a semiconductor substrate. The signal read circuits are configured by, in the case of a CCD device, charge transfer circuits and transfer electrodes, and, in the case of a CMOS device, MOS circuits and signal lines.

In the related-art solid-state image pickup apparatus, therefore, many light receiving portions and signal read circuits must be formed on the same surface of a semiconductor substrate, thereby producing a problem in that the area for the light receiving portions cannot be increased.

The related-art single-type solid-state image pickup apparatus has a configuration in which one of color filters of, for example, red (R), green (G), and blue (B) is stacked on each of light receiving portions, so that the light receiving portion detects a light signal of the one color. In the position of a light receiving portion which detects light of, for example, red, therefore, blue and green signals are obtained by interpolating detection signals of surrounding light receiving portions which detect blue light and green light, respectively. This causes a false color, and reduces the resolution. Furthermore, blue light and green light incident on a light receiving portion where a red color filter is formed does not contribute to photoelectric conversion, but is absorbed as heat into the color filter, thereby producing another problem in that the light use efficiency is poor and the sensitivity is low.

As described above, the related-art solid-state image pickup apparatus has various problems. On the other hand, in such a device, the number of pixels is advancing. At present, a large number or several millions of pixels or light receiving portions are integrated on one semiconductor substrate, and the size of an opening of each of the light receiving portions is near the order of the wavelength. Consequently, a CCD device and a CMOS device are hardly expected to configure an image sensor which can solve the above-discussed problems, and which is superior in image quality and sensitivity than the related-art one.

Therefore, attention is again paid to the structure of a solid-state image pickup apparatus which is disclosed in, for example, JP-A-58-103165. The solid-state color image pickup apparatus has a structure where a red-detection photosensitive layer, a green-detection photosensitive layer, and a blue-detection photosensitive layer are stacked by a film growth technique on a semiconductor substrate in which signal read circuits are formed on the surface, these photosensitive layers are used as light receiving portions, and photoelectric conversion signals obtained in the photosensitive layers are supplied to the outside by the signal read circuits. Namely, the solid-state image pickup apparatus has a structure of a photoelectric converting film stack type.

In this structure, it is not required to dispose the light receiving portions on the surface of the semiconductor substrate. Therefore, restrictions on the design of the signal read circuits are largely eliminated, and the use efficiency of incident light is improved, so that the sensitivity is enhanced. Moreover, one pixel can detect light of the three primary colors red, green, and blue. Therefore, the resolution is improved, and a false color does not occur. As a result, it is possible to solve the above-discussed problems of the related-art CCD or CMOS solid-state image pickup apparatus.

Consequently, solid-state image pickup apparatuss of the photoelectric converting film stack type disclosed in JP-A-2002-83946, JP-T-2002-502120, JP-T-2003-502847 and Japanese Patent No. 3,405,099 have been proposed. In such devices, an organic semiconductor or nanoparticles are used as the photosensitive layers.

Among the related-art CMOS solid-state image pickup apparatuss, as disclosed in JP-T-2002-513145, a device has been developed. In the device, the phenomenon that the distance by which light penetrates into a semiconductor substrate is varied depending on the wavelength of the light is used, and, by means of three photodiodes that are formed in the depth direction of the semiconductor substrate, each pixel detects the three primary colors red, green, and blue without using a color filter.

In a solid-state color image pickup apparatus of the photoelectric converting film stack type, or the related-art solid-state image pickup apparatus in which three photodiodes are formed in the depth direction of a semiconductor substrate, each of pixels can detect the three primary colors without using a color filter, and hence the problem of a false color and the other problems can be solved. When the number of pixels is increased, however, the amount of signal charges which can be detected by each pixel is reduced, thereby causing a further problem in that the dynamic range is lowered.

### SUMMARY OF THE INVENTION

It is an object of the invention to provide a solid-state color image pickup apparatus which is configured so that each pixel detects photoelectric conversion signals of plural colors, and in which the dynamic range can be widened, and also to provide a digital camera on which such a solid-state image pickup apparatus is mounted.

According to the invention, there is provided a solid-state color image pickup apparatus comprising a plurality of pixels, wherein said plurality of pixels are arranged to form an array pattern comprising a first checkered pattern and a second checkered pattern, wherein each of said plurality of pixels detects colors signals of red, green, and blue, and wherein said plurality of pixels comprises: higher-sensitivity pixels forming the first checkered pattern; and lower-sensitivity pixels forming the second checkered pattern.

According to the configuration, it is possible to take a color image of a wide dynamic range.

According to the invention, there is provided a solid-state color image pickup apparatus, wherein the higher-sensitivity pixels have larger areas and the lower-sensitivity pixels have smaller areas.

According to the configuration, the device can be easily produced while the higher-sensitivity pixels are separated from the lower-sensitivity pixels.

According to the invention, there is provided a solid-state color image pickup apparatus, wherein each of the higher-sensitivity pixels comprises microlense, and each of lower-sensitivity pixels comprises no microlense.

According to the configuration, the higher-sensitivity pixels and the lower-sensitivity pixels can be produced by the same size, and hence the pixels can be easily produced.

According to the invention, there is provided a solid-state color image pickup apparatus: a semiconductor substrate including signal read circuits; photoelectric converting films stacked above the semiconductor substrate, the photoelectric converting films comprising a photoelectric converting film for detecting red, a photoelectric converting film for detecting green, a photoelectric converting film for detecting blue; and a plurality of pixel electrode films each of which is provided at each of the photoelectric converting films so as to define each of said plurality of pixels.

When the solid-state color image pickup apparatus is formed as a device of the photoelectric converting film stack type, a large light receiving area can be ensured, the light use efficiency is improved, and restrictions on the design of the signal read circuits to be disposed in the semiconductor substrate are largely relaxed.

According to the invention, there is provided a solid-state color image pickup apparatus, further comprising a plurality of light receiving portions each of which corresponds each of said plurality of pixels, wherein each of said plurality of light receiving portions a photodiode for detecting red, a photodiode for detecting green, and a photodiode for detecting blue in a depth direction of the semiconductor substrate.

According to the configuration, it is possible to use the known production technique for a CCD or CMOS image sensor, as it is.

According to the invention, there is provided a digital camera comprising one of the above solid-state color image pickup apparatuss.

According to the configuration, it is possible to take a color image in which the dynamic range is wide, the light use efficiency is high, a false color is not caused, and the resolution is high.

According to the invention, there is provided a digital camera, further comprising: a image signal processing section that performs: interpolating higher-sensitivity color signals which are output from the higher-sensitivity pixels of the solid-state color image pickup apparatus, to produce higher-sensitivity imaginary pixel color signals at imaginary pixel positions of the higher-sensitivity pixels; interpolating lower-sensitivity color signals which are output from the lower-sensitivity pixels, to produce lower-sensitivity imaginary pixel color signals at imaginary pixel positions of the lower-sensitivity pixels; and combining the higher-sensitivity imaginary pixel color signals with the lower-sensitivity imaginary pixel color signals to produce a color image signal.

According to the configuration, it is possible to output a color image of a higher resolution.

According to the invention, there is provided a digital camera, further comprising: a mechanical shutter; and a sensitivity adjusting section that performs: discharging first signal charges which are accumulated as a result of photoelectric conversion in the lower-sensitivity pixels at a first timing during a period when the mechanical shutter is opened; and reading out, as signals of the lower-sensitivity pixels, signals corresponding to second signal charges which are accumulated as a result of photoelectric conversion in the lower-sensitivity pixels during a period from the first timing to a second timing when the mechanical shutter is closed.

According to the invention, there is provided a digital camera, further comprising: a mechanical shutter; and a sensitivity adjusting section that performs: discharging first signal charges which are accumulated as a result of photoelectric conversion in the higher-sensitivity pixels at a first timing during a period when the mechanical shutter is opened; and reading out, as signals of the higher-sensitivity pixels, signals corresponding to second signal charges which are accumulated as a result of photoelectric conversion in the higher-sensitivity pixels during a period from the first timing to a second timing when the mechanical shutter is closed.

According to the configuration, the sensitivity ratio of the higher-sensitivity pixels and the lower-sensitivity pixels can be adjusted to an arbitrary value suitable for an imaging scene.

### BRIEF DESCRIPTION OF THE DRAWINGS

FIG. 1 is a block diagram of a digital camera on which a solid-state color image pickup apparatus of the photoelectric converting film stack type of a first embodiment of the invention is mounted;

FIG. 2 is a surface diagram of the photoelectric converting film stack type solid-state color image pickup apparatus shown in FIG. 1;

FIG. 3 is a detailed diagram of the configuration of an image signal processing section shown in FIG. 1;

FIG. 4 is a diagram showing relationships between higher-sensitivity pixels and lower-sensitivity pixels, and vertical transfer paths in the photoelectric converting film stack type solid-state color image pickup apparatus shown in FIG. 1;

FIG. 5 is a schematic section view taken along the line V-V of FIG. 4;

FIG. 6 is a surface diagram of the vertical transfer paths shown in FIG. 4;

FIG. 7 is a diagram of a photoelectric converting film stack type solid-state color image pickup apparatus of a second embodiment of the invention, and corresponding to FIG. 4;

FIG. 8 is a surface diagram of vertical transfer paths in the photoelectric converting film stack type solid-state color image pickup apparatus of the second embodiment of the invention;

FIG. 9 is a timing chart of a sensitivity ratio adjustment in the photoelectric converting film stack type solid-state color image pickup apparatus of the second embodiment of the invention;

FIG. 10 is a circuit diagram of signal read circuits of a photoelectric converting film stack type solid-state color image pickup apparatus of a third embodiment of the invention;

FIG. 11 is a timing chart of a sensitivity ratio adjustment in the photoelectric converting film stack type solid-state color image pickup apparatus of the third embodiment of the invention; and

FIG. 12 is a circuit diagram of signal read circuits of a photoelectric converting film stack type solid-state color image pickup apparatus of a fourth embodiment of the invention.

### DETAILED DESCRIPTION OF THE INVENTION

Hereinafter, embodiments of the invention will be described with reference to the accompanying drawings.

### First Embodiment

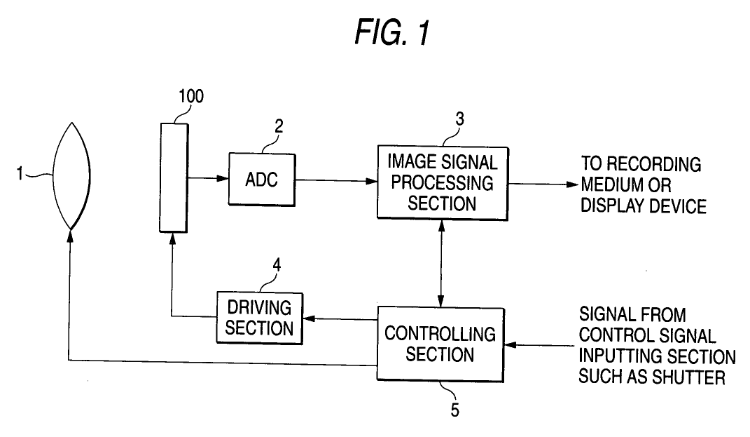

FIG. 1 is a block diagram of a digital camera on which a solid-state color image pickup apparatus of the photoelectric converting film stack type of a first embodiment of the invention is mounted. The digital camera comprises: an imaging optical system 1 including an imaging lens, an aperture, and a shutter; the solid-state color image pickup apparatus 100 of the photoelectric converting film stack type which will be described later in detail; an analog/digital converter 2 which converts an analog image signal output from the photoelectric converting film stack type solid-state color image pickup apparatus 100, to a digital signal; an image signal processing section 3 which applies image processing on the digital image signal, and which stores the processed signal onto a recording medium, or displays it on a display device; a driving section 4 which controls the operation of the photoelectric converting film stack type solid-state color image pickup apparatus 100; and a controlling section 5 which receives signals from an operation section including a shutter button, and which controls the image signal processing section 3 and the driving section 4, and the imaging optical system 1.

In the case where an analog/digital converting device is disposed integrally in an output stage of the photoelectric converting film stack type solid-state color image pickup apparatus 100, the analog/digital converter 2 is not required.

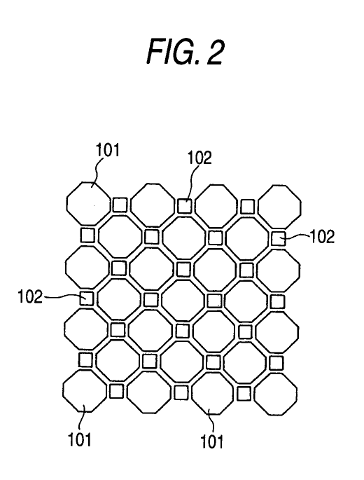

FIG. 2 is a surface diagram of the photoelectric converting film stack type solid-state color image pickup apparatus 100. In the photoelectric converting film stack type solid-state color image pickup apparatus 100, higher-sensitivity pixels 101 of a larger area and lower-sensitivity pixels 102 of a smaller area are formed alternately in both the horizontal and vertical directions so as to be arranged in a square lattice as a whole. The arrangement of only the higher-sensitivity pixels 101 is formed as a checkered pattern, and also that of only the lower-sensitivity pixels 102 is formed as a checkered pattern.

In the example of FIG. 2, the higher-sensitivity pixels 101 have a larger area, and the lower-sensitivity pixels 102 have a smaller area. Alternatively, another configuration may be employed in which the higher-sensitivity pixels 101 and the lower-sensitivity pixels 102 have the same area, and microlenses are mounted only on the higher-sensitivity pixels 101 so that incident light of an area which is larger than the area of the lower-sensitivity pixels 102 is focused on the higher-sensitivity pixels 101.

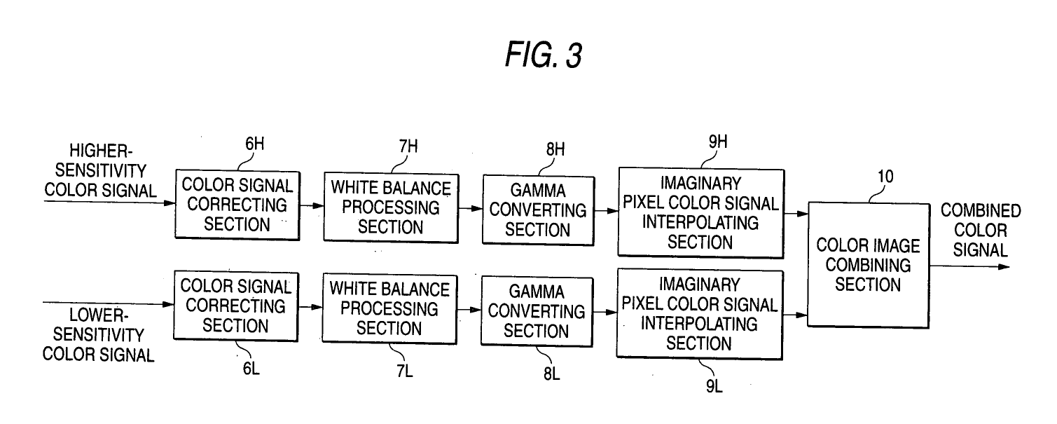

FIG. 3 is a diagram of the configuration of the image signal processing section 3 shown in FIG. 1. The higher-sensitivity pixels 101 of the photoelectric converting film stack type solid-state color image pickup apparatus 100 output higher-sensitivity color signals, and the lower-sensitivity pixels 102 output lower-sensitivity color signals. The image signal processing section 3 separately processes the higher-sensitivity color signals and the lower-sensitivity color signals, and then combines the signals with each other.

Therefore, the image signal processing section 3 comprises: a color signal correcting section 6H which processes the higher-sensitivity color signals; a white balance processing section 7H; a gamma converting section 8H; an imaginary pixel color signal interpolating section 9H; a color signal correcting section 6L which processes the lower-sensitivity color signals; a white balance processing section 7L; a gamma converting section 8L; an imaginary pixel color signal interpolating section 9L; and a color image combining section 10 which combines together the higher-sensitivity color signals and the lower-sensitivity color signals that are output from the imaginary pixel color signal interpolating sections 9H, 9L.

The imaginary pixel color signal interpolation will be described. In the center of four higher-sensitivity pixels 101 which are adjacent to each other in the horizontal and vertical directions, for example, none of the higher-sensitivity pixels 101 exists, and one of the lower-sensitivity pixels 102 exists. In other words, as viewed from the higher-sensitivity pixels 101, the positions where the lower-sensitivity pixels 102 exist are pixel (imaginary pixel) positions where none of the higher-sensitivity pixels 101 exists. By contrast, the positions where the higher-sensitivity pixels 101 exist are pixel (imaginary pixel) positions where none of the lower-sensitivity pixels 102 exists.

In these imaginary pixel positions, the higher-sensitivity color signals and the lower-sensitivity color signals are obtained by interpolating the higher-sensitivity color signals and the lower-sensitivity color signals which are obtained from surrounding real pixels. Hereinafter, for the sake of convenience, the real pixel position of each of the higher-sensitivity pixels 101 is referred to as H lattice point, and the real pixel position of each of the lower-sensitivity pixels 102 is referred to as L lattice point.

Color signals of red (R), green (G), and blue (B) which are output from the photoelectric converting film stack type solid-state color image pickup apparatus 100 and then A/D converted have poor color reproducibility. Therefore, the color signal correcting sections 6H, 6L correct the color signals by matrix operations shown in Expressions 1 and 2 below, respectively.

For the actual higher-sensitivity color signals at an H lattice point,

$$( \begin{matrix}{S}_{RH}^{′} ( x , y ) \\ {S}_{GH}^{′} ( x , y ) \\ {S}_{BH}^{′} ( x , y )\end{matrix} ) = ( \begin{matrix}{G}_{11} & {G}_{21} & {G}_{31} \\ {G}_{12} & {G}_{22} & {G}_{32} \\ {G}_{13} & {G}_{23} & {G}_{33}\end{matrix} ) ( \begin{matrix}{S}_{RH} ( x , y ) \\ {S}_{GH} ( x , y ) \\ {S}_{BH} ( x , y )\end{matrix} ) \qquad [ Ex . 1 ]$$

where S_{RH} (x, y), S_{GH} (x, y), and S_{BH} (x, y) are actual higher-sensitivity color signals for RGB at H lattice point (x, y); S′_{RH}(x, Y), S′_{GH}(x, Y), and S′_{BH}(x, y) are corrected higher-sensitivity color signals for RGB; and G_{11 to G}₃₃ are constants.

Similarly, for actual lower-sensitivity color signals at an L lattice point,

$$( \begin{matrix}{S}_{RL}^{′} ( x , y ) \\ {S}_{GL}^{′} ( x , y ) \\ {S}_{BL}^{′} ( x , y )\end{matrix} ) = ( \begin{matrix}{G}_{11} & {G}_{21} & {G}_{31} \\ {G}_{12} & {G}_{22} & {G}_{32} \\ {G}_{13} & {G}_{23} & {G}_{33}\end{matrix} ) ( \begin{matrix}{S}_{RL} ( x , y ) \\ {S}_{GL} ( x , y ) \\ {S}_{BL} ( x , y )\end{matrix} ) \qquad [ Ex . 2 ]$$

where S_{RL}(x, Y), S_{GL}(x, y), and S_{BL}(x, y) are actual lower-sensitivity color signals for RGB at L lattice point (x, y); S′_{RL}(x, Y), S′_{GL}(x, Y), and S′_{BL}(x, y) are corrected color signals for RGB; and G₁₁ to G₃₃ are constants.

The white balance processing sections 7H, 7L in the next stage adjust the gains so that, when uniform white is imaged, the input RGB color signals attain the ratio of R:G:B=1:1:1, and output the gain-adjusted signals.

The gamma converting sections 8H, 8L in the next stage conduct a nonlinear process corresponding to the gamma characteristics, on the input RGB color signals, and output the processed signals. In this case, different nonlinear processes may be applied to the higher-sensitivity color signals and the lower-sensitivity color signals, or the same nonlinear processes may be applied. The case of different processes has an advantage that the gamma characteristic after the combining process can be adjusted, and that of the same process has an advantage that the load required in the process (increase of the process time and increase of the number of gates) can be reduced.

The imaginary pixel color signal interpolating sections 9H, 9L in the next stage check features of local patterns of the high- and lower-sensitivity color signals, and produce color signals at imaginary pixel positions for the high- and lower-sensitivity color signals, respectively. For example, the sections produce color signals at imaginary pixel positions by following Expression 3.

$$G ( x , y ) = \{ \begin{matrix}( G ( x , y - 1 ) + G ( x , y + 1 ) ) / 2 & ( in the case of Z < - K ) \\ ( G ( x - 1 , y ) + G ( x + 1 , y ) ) / 2 & ( in the case of Z > K ) \\ ( G ( x , y - 1 ) + G ( x , y + 1 ) + & ( in the case other than \\ G ( x - 1 , y ) + G ( x + 1 , y ) ) / 4 & the above )\end{matrix} \qquad [ Ex . 3 ]$$

where G(x, y) means the higher-sensitivity color signals in the case where the pixel position (x, y) is an L lattice point, and the lower-sensitivity color signals in the case where the pixel position (x, y) is an H lattice point, K is a positive constant, and Z is indicated by following Expression 4.
   Z=|G(x,y−1)−G(x,y+1)1−|G(x−1,y)−G(x+1,y)| [Ex. 4]

The color image combining section 10 in the next stage produces combined color signals by following Expression 5 from the high- and lower-sensitivity color signals at the same pixel position (including an imaginary pixel position).
R_{comp}(x,y)=αR_{H}(x,y)+(1−α)R_{L}(x,y)
G_{comp}(x,y)=αG_{H}(x,y)+(1−α)G_{L}(x,y)
B_{comp}(x,y)=αB_{H}(x,y)+(1−α)B_{L}(x,y) [Ex. 5]
where R_{comp}(x, y), G_{comp}(x, y), and B_{comp}(x, y) are combined color signals of red (R), green (G), and blue (B) at the pixel position (x, y); R_{H}(x, y), G_{H}(x, y), and B_{H}(x, y) are the higher-sensitivity color signals of red (R), green (G), and blue (B) at the pixel position (x, y); R_{L}(x, y), G_{L}(x, y), and B_{L}(x, y) are the lower-sensitivity color signals of red (R), green (G), and blue (B) at the pixel position (x, y); and α is a combination parameter which is a constant in the range of 0 to 1. Preferably, α has a value of 0.5 to 0.8.

In the example of FIG. 3, the color signals of an imaginary pixel are produced after the gamma conversion. Alternatively, the production may be conducted before the gamma conversion, or before the white balancing process. Although the color image combination is conducted with using the parameter a, the manner of the color image combination is not restricted to this, and another combining method may be used.

In the above, the description has been made under the assumption that the solid-state image pickup apparatus outputs signals of the three primary colors red (R), green (G), and blue (B). For example, a solid-state image pickup apparatus may be used which outputs also a color signal of a wavelength that is intermediate between green (G) and blue (B), in addition to the signals of the three primary colors. In this case, the same processes may be conducted except that the color signal correcting sections of FIG. 3 conduct a 3×4 matrix operation to convert four color signals to three color signals of RGB (for example, a signal which is obtained by retracting the amount of the signal of the fourth color from that of the red signal is set as the red signal, thereby realizing the human visibility.).

Incidentally, the image signal processing section that performs functions of the invention is not limited to the above-mentioned embodiment.

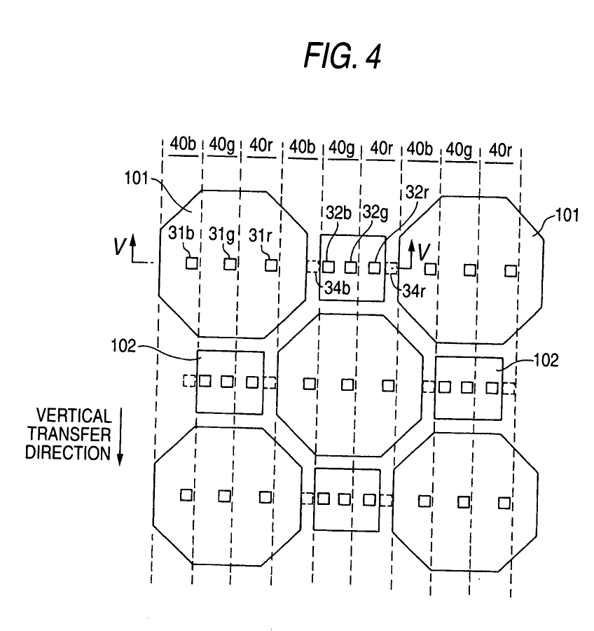

FIG. 4 is a diagram showing relationships between the higher-sensitivity pixels 101 and the lower-sensitivity pixels 102, and vertical transfer paths which are formed below the pixels. The higher-sensitivity pixels 101 and the lower-sensitivity pixels 102 are connected to the side of the vertical transfer paths through vertical lines which will be described later. FIG. 4 shows also the positions of the vertical lines which are placed below the pixels and hence cannot be seen from the upper side in an actual state.

In each of the higher-sensitivity pixels 101, three longitudinal lines or a longitudinal line 31b for a blue signal, a longitudinal line 31g for a green signal, and a longitudinal line 31r for a red signal are disposed. The longitudinal lines 31b, 31g, 31r are straightly erected at the illustrated positions. Three vertical transfer paths 40b, 40g, 40r having the same width are formed in the semiconductor substrate which is immediately below the higher-sensitivity pixels 101. The subscripts r, g, b correspond to red (R), green (G), and blue (B) which are colors of the incident light to be detected, respectively. This is applicable also to the following description.

Blue signal charges generated by a blue-photoelectric converting film which will be described later are accumulated through the longitudinal line 31b into a signal charge accumulating region that is formed directly below the film. The signal charges are read out to the vertical transfer path 40b to be transferred.

Similarly, green signal charges generated by a green-photoelectric converting film which will be described later are accumulated through the longitudinal line 31g into a signal charge accumulating region that is formed directly below the film. The signal charges are read out to the vertical transfer path 40g to be transferred.

Similarly, red signal charges generated by a red-photoelectric converting film which will be described later are accumulated through the longitudinal line 31r into a signal charge accumulating region that is formed directly below the film. The signal charges are read out to the vertical transfer path 40r to be transferred.

In each of the lower-sensitivity pixels 102, three longitudinal lines 32b, 32g, 32r are disposed. Since the lower-sensitivity pixels 102 are smaller in area than the higher-sensitivity pixels 101, however, the intervals of the longitudinal lines 32b, 32g, 32r are small. When the center longitudinal line 32g corresponding to green is straightly downward elongated so as to coincide with a signal charge accumulating region disposed in the center vertical transfer path 40g, therefore, the longitudinal line 32b is deviated from a signal charge accumulating region 34b disposed in the vertical transfer path 40b, and also the longitudinal line 32r is deviated from a signal charge accumulating region 34r disposed in the vertical transfer path 40r.

For the longitudinal lines 32b, 32r, therefore, lateral wires which will be described later are disposed at an intermediate position, so that blue signal charges and red signal charges are accumulated into the signal charge accumulating regions 34b, 34r, respectively. According to the configuration, color signal charges due to the higher-sensitivity pixels 101, and those due to the lower-sensitivity pixels 102 can be transferred through the same corresponding vertical transfer paths which are disposed respectively for the colors.

Specifically, the blue signal charges due to the higher-sensitivity pixels 101, and those due to the lower-sensitivity pixels 102 are transferred through the same vertical transfer path 40b, the green signal charges due to the higher-sensitivity pixels 101, and those due to the lower-sensitivity pixels 102 are transferred through the same vertical transfer path 40g, and the red signal charges due to the higher-sensitivity pixels 101, and those due to the lower-sensitivity pixels 102 are transferred through the same vertical transfer path 40r.

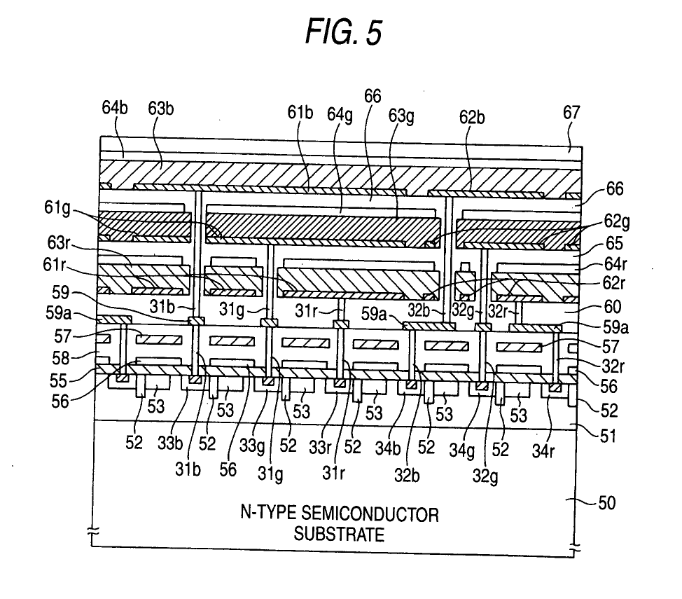

FIG. 5 is a schematic section view taken along the line V-V of FIG. 4, and showing the vicinity of the longitudinal lines of the higher-sensitivity pixels 101 and the lower-sensitivity pixels 102. A P-well layer 51 is formed in a surface portion of an n-type semiconductor substrate 50, and the surface portion is partitioned into vertical transfer paths by channel stops (P⁺ regions) 52. In each of the intervals between the channel stops 52, an n-type semiconductor region 53 constituting a vertical transfer path, and the signal charge accumulating region (n-type semiconductor region) 33r or the like of the corresponding color are formed so as to be slightly separated from each other.

The signal charge accumulating regions 33b, 33g, 33r, 34b, 34g, 34r are formed in the same size. The longitudinal lines 31b, 31g, 31r, 32b, 32g, 32r are connected to the portions, respectively.

A gate insulating film 55 is formed on the surface of the semiconductor, and a transfer electrode film 56 made of polysilicon is formed on the insulating film.

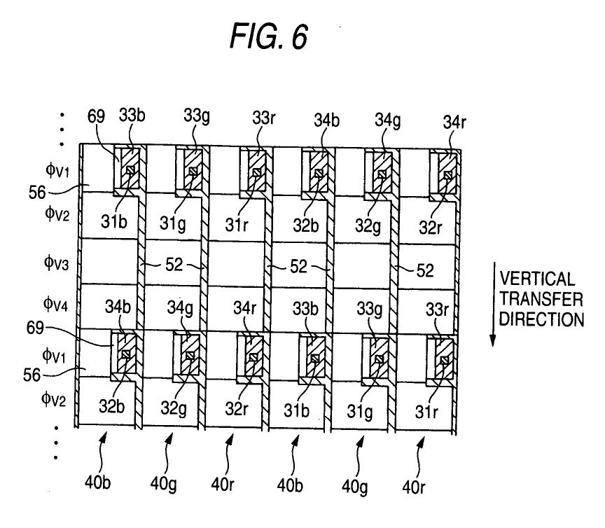

FIG. 6 is a surface diagram of the vertical transfer paths. In the figure, six vertical transfer paths 40b, 40g, 40r, 40b, 40g, 40r are shown. At the same vertical position (first-phase transfer electrode region) Φv1 of the vertical transfer paths, disposed are: the signal charge accumulating regions 33b into which blue signal charges that are supplied from the higher-sensitivity pixels 101 through the longitudinal lines 31b are accumulated; the signal charge accumulating regions 33g into which green signal charges that are supplied from the higher-sensitivity pixels 101 through the longitudinal lines 31g are accumulated; and the signal charge accumulating regions 33r into which red signal charges that are supplied from the higher-sensitivity pixels 101 through the longitudinal lines 31r are accumulated.

At the same vertical positions, similarly, disposed are: the signal charge accumulating regions 34b into which blue signal charges that are supplied from the lower-sensitivity pixels 102 through the longitudinal lines 32b are accumulated; the signal charge accumulating regions 34g into which green signal charges that are supplied from the lower-sensitivity pixels 102 through the longitudinal lines 32g are accumulated; and the signal charge accumulating regions 34r into which red signal charges that are supplied from the lower-sensitivity pixels 102 through the longitudinal lines 32r are accumulated.

The first-phase transfer electrode region Φv1 (=the transfer electrode film 56 in FIG. 5, functioning also as a read gate electrode) is vertically followed by a second-phase transfer electrode region Φv2, a third-phase transfer electrode region Φv3, and a fourth-phase transfer electrode region Φv4. In the next first-phase transfer electrode region Φv1, the positional relationship between the higher-sensitivity pixels 101 and the lower-sensitivity pixels 102 is inverted, and hence the signal charge accumulating regions 34b, 34g, 34r for the lower-sensitivity pixels 102 and the signal charge accumulating regions 33b, 33g, 33r for the higher-sensitivity pixels 101 are arranged in this sequence as starting from the left side of FIG. 6.

Referring again to FIG. 5, the surface of the semiconductor substrate in which the transfer electrode film 56 constituting the vertical transfer paths is formed is covered by an insulating film 58 in which a light shielding film 57 is interposed. A conductor film 59 is formed on the insulating film 58. The conductor film 59 is patterned so as to be formed as connecting portions for respectively connecting the longitudinal lines 31b, 31g, 31r, 32b, 32g, 32r which are in the lower layer, with the longitudinal lines 31b, 31g, 31r, 32b, 32g, 32r which are in the upper layer.

Specifically, a lateral line 59a is formed by patterning. The lateral line is used for connecting the longitudinal lines 32b, 32r which have been described with reference to FIG. 4, and which are on both sides of each lower-sensitivity pixel (small pixel) 102, with the signal charge accumulating regions 34b, 34r of the vertical transfer paths 40b, 40r.

An insulating film 60 is stacked on the patterned conductor film 59, and electrode films (hereinafter, referred to as pixel electrode films) 61r, 62r which are partitioned for each pixel are formed on the insulating film. The pixel electrode film 61r defines the higher-sensitivity pixels 101, and has an octagonal shape in the example of FIG. 4. The pixel electrode film 62r defines the lower-sensitivity pixels 102, and has a square shape in the example of FIG. 4. The longitudinal line 31r is connected to the pixel electrode film 61r, and the longitudinal line 32r is connected to the pixel electrode film 62r.

A photoelectric converting film 63r for detecting red (R) is stacked on the pixel electrode films 61r, 62r. The photoelectric converting film 63r is not required to be disposed with being partitioned for respective pixels, and is stacked as a single film over the whole light receiving surface.

A common electrode film 64r which is commonly used for the pixels 101, 102 for detecting a red signal is stacked on the photoelectric converting film 63r, similarly as a single film. A transparent insulating film 65 is stacked on the common electrode film.

Alternatively, the common electrode film 64r may be patterned so as to be partitioned for respective pixels. In the alternative, the pattering process is conduct so that a line portion for connecting the patterned electrode films 64r with each other remains, because the same bias voltage is to be applied to the electrode films 64r.

Pixel electrode films 61g, 62g which are partitioned for respective pixels are formed above the insulating film 65. The pixel electrode film 61g defines the higher-sensitivity pixels 101, and has an octagonal shape which is identical with that of the pixel electrode film 61r. The pixel electrode film 62g defines the lower-sensitivity pixels 102, and has a square shape which is identical with that of the pixel electrode film 62r. The longitudinal line 31g is connected to the pixel electrode film 61g, and the longitudinal line 32g is connected to the pixel electrode film 62g.

A photoelectric converting film 63g for detecting green (G) is stacked on the pixel electrode films 61g, 62g, as a single film in the same manner as described above. A common electrode film 64g is stacked on the photoelectric converting film, and a transparent insulating film 66 is stacked on the common electrode film.

Pixel electrode films 61b, 62b which are partitioned for respective pixels are formed on the insulating film 66. The pixel electrode film 61b defines the higher-sensitivity pixels 101, and has an octagonal shape which is identical with that of the pixel electrode film 61r. The pixel electrode film 62b defines the lower-sensitivity pixels 102, and has a square shape which is identical with that of the pixel electrode film 62r. The longitudinal line 31b is connected to the pixel electrode film 61b, and the longitudinal line 32b is connected to the pixel electrode film 62b.

A photoelectric converting film 63b for detecting blue (B) is stacked on the pixel electrode films 61b, 62b, as a single film in the same manner as described above. A common electrode film 64b is stacked on the photoelectric converting film, and a transparent insulating film 67 is stacked in the uppermost layer.

The pixel electrode films 61r, 61g, 61b corresponding to the higher-sensitivity pixels 101 are disposed so as to be aligned in the direction of incident light, and also the pixel electrode films 62r, 62g, 62b corresponding to the lower-sensitivity pixels 102 are disposed so as to be aligned in the direction of incident light.

Namely, the photoelectric converting film stack type solid-state color image pickup apparatus 100 of the embodiment is configured so that each of the pixel detects the three colors of red (R), green (G), and blue (B). Hereinafter, the term of higher-sensitivity “pixel” or lower-sensitivity “pixel” means the pixel 101 or 102 which detects the three colors, and the term of a color pixel, a red pixel, a green pixel, or a blue pixel means a partial pixel (a portion of a photoelectric converting film sandwiched between the common electrode film and one pixel electrode film) which detects the corresponding color.

As the homogeneous and transparent electrode films 61r, 61g, 61b, 62r, 62g, 62b, 64r, 64g, 64b, thin films of tin oxide (SnO₂), titanium oxide (TiO₂), indium oxide (InO₂), or indium tin oxide (ITO) are used. However, the materials of the films are not restricted to these oxides.

The photoelectric converting films 63r, 63g, 63b may be formed by a single-layer film or a multilayer film. As the materials of the films, useful are various materials such as: silicon, a compound semiconductor, and a like organic material; an organic material including an organic semiconductor and organic pigment; and a quantum dot deposition film configured by nanoparticies.

When light is incident on the photoelectric converting film stack type solid-state color image pickup apparatus 100 having the above-described configuration, blue light of the incident light causes photoelectric conversion in the blue-photoelectric converting film 63b, green light causes photoelectric conversion in the green-photoelectric converting film 63g, and red light causes photoelectric conversion in the red-photoelectric converting film 63r, thereby generating signal charges which correspond to the amounts of the incident color lights, respectively.

When a voltage is applied between the common electrode films 64r, 64g, 64b, and the pixel electrode films 61r, 61g, 61b, 62r, 62g, 62b, signal charges generated in the pixels flow into the signal charge accumulating regions 33r, 33g, 33b, 34r, 34g, 34b through the corresponding longitudinal lines 31r, 31g, 31b, 32r, 32g, 32b, to be accumulated thereinto.

The amount of light incident on the higher-sensitivity pixels 101 is larger than that of light incident on the lower-sensitivity pixels 102. Even when the amount of signal charges generated in the higher-sensitivity pixels 101 is saturated, therefore, saturation does not occur in the lower-sensitivity pixels 102.

Therefore, red signal charges, green signal charges, and blue signal charges due to the higher-sensitivity pixels 101, and red signal charges, green signal charges, and blue signal charges due to the lower-sensitivity pixels 102 are read into the first-phase transfer electrode region Φv1 through read gate portions 69 disposed on the side of the signal charge accumulating regions 33r, 33g, 33b, 34r, 34g, 34b of FIG. 6. Thereafter, the charges are transferred to the second-, third-, . . . , phase transfer electrode regions until the charges reach a horizontal transfer path which is not shown. The charges are then transferred through the horizontal transfer path, thereby causing the solid-state color image pickup apparatus 100 to output higher-sensitivity color signals and lower-sensitivity color signals. The output signals are processed by the image signal processing circuit of FIG. 3, with the result that a color image of a wide dynamic range can be obtained.

### Second Embodiment

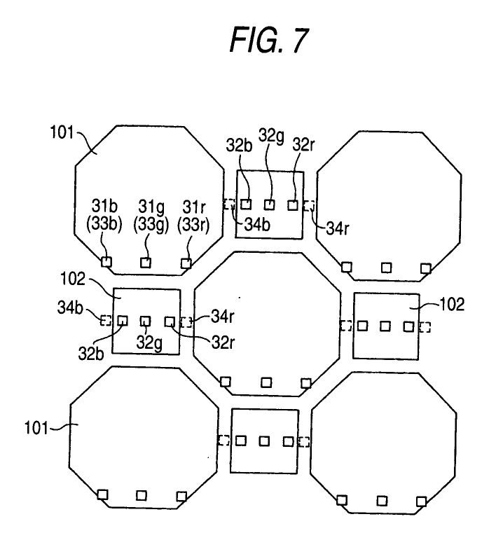

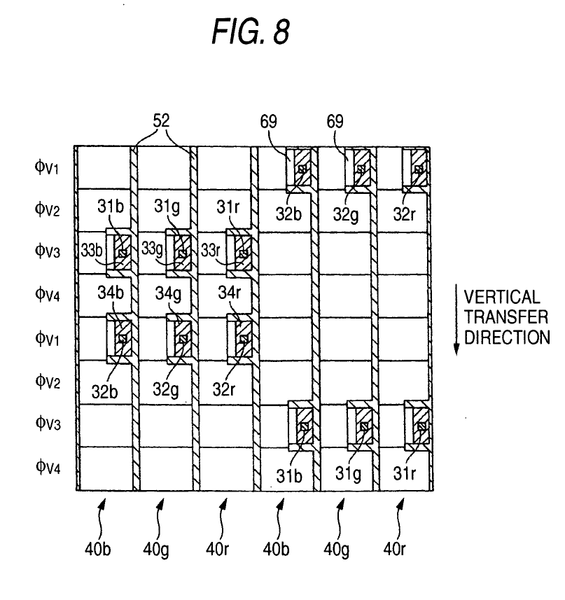

FIG. 7 is a surface diagram of a photoelectric converting film stack type solid-state color image pickup apparatus of a second embodiment of the invention, and corresponds to FIG. 4 of the first embodiment. FIG. 8 is a surface diagram of vertical transfer paths formed on the surface of the semiconductor substrate, and showing a portion corresponding to four pixels (two higher-sensitivity pixels×two lower-sensitivity pixels). FIG. 8 corresponds to FIG. 6 of the first embodiment.

The second embodiment is characterized in that the positions to which the longitudinal lines 31b, 31g, 31r disposed in each of the higher-sensitivity pixels 101 are downward elongated, i.e., the vertical positions of the signal charge accumulating regions 33b, 33g, 33r are shifted by a distance corresponding to two transfer electrode regions from the vertical positions where the signal charge accumulating regions 34b, 34g, 34r to which the longitudinal lines 32b, 32g, 32r disposed in each of the lower-sensitivity pixels 102 are downward elongated are disposed.

In the first embodiment, the sensitivity ratio of the higher-sensitivity pixels 101 and the lower-sensitivity pixels 102 (the sensitivity of the higher-sensitivity pixels/that of the lower-sensitivity pixels) is determined by differences in structural factors such as the opening area of each pixel, and the size of the microlenses, and has a fixed value. In an actual imaging scene, however, it is preferable to conduct an imaging process while adjusting the sensitivity ratio to an optimum value. Therefore, the second embodiment is provided with the configuration of FIGS. 7 and 8 in order to enable the sensitivity ratio to be adjustably set.

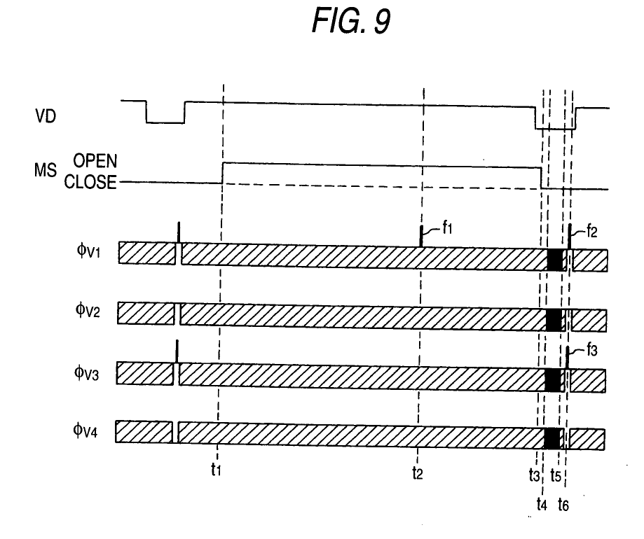

FIG. 9 is a timing chart of the operation of a digital camera on which the photoelectric converting film stack type solid-state color image pickup apparatus of the embodiment is mounted. The digital camera is configured in the same manner as FIGS. 1 and 3, and the controlling section 5 drives via the driving section 4 the photoelectric converting film stack type solid-state color image pickup apparatus 100 shown in FIGS. 7 and 8, in the following manner. In FIG. 9, the hatched portions indicate areas where illustration of continuous transfer pulses is omitted.

At intermediate (time t₂) during a period (t₁ to t₃) when a mechanical shutter MS constituting the optical system 1 is opened, a read pulse f1 is applied to the region Φv1 serving as a read electrode for the lower-sensitivity pixels 102, so that charges accumulated in all the lower-sensitivity pixels 102 and the signal charge accumulating regions 34b, 34g, 34r for the pixels are read out to the vertical transfer paths 40b, 40g, 40r. During a period (t₄ to t₅) after the mechanical shutter is closed, high-speed sweep-out pulses are applied to the vertical transfer paths (the application period is blacked out because the pulses are so dense), thereby eliminating unwanted charges in the vertical transfer paths.

At time t₆, read pulses f2, f3 are applied to the regions Φv1, Φv3 to read out the color signal charges of the higher-sensitivity pixels 101 and the lower-sensitivity pixels 102 to the vertical transfer paths. The color signal charges are transferred to the horizontal transfer path, and then supplied to the outside from the horizontal transfer path.

In the lower-sensitivity pixels 102, after timing t₁ when the mechanical shutter is opened, light is incident on the pixels and photoelectric conversion signals are generated. However, the read pulse f1 is applied at time t₂, and hence the signal charges accumulated during the period of t₁−t₂ are discharged to the vertical transfer paths to be swept out by the high-speed sweep-out pulses.

Photoelectric conversion signals which are generated by light incident after time t₂ are accumulated. The signals are read out to the vertical transfer paths in response to the read pulse f2, to be transferred therethrough. Consequently, the sensitivity of the lower-sensitivity pixels 102 is reduced by the factor of (t₃−t₂)/(t₃−t₁). Namely, the sensitivity ratio can be set to a value suitable for an imaging scene by adjusting the timing of the read pulse f1. The sensitivity of the higher-sensitivity pixels 101 can be reduced in a similar manner.

As described above, the controlling section 5 can serves as a sensitivity adjusting section. However, the sensitivity adjusting section is not limited to the above-mentioned embodiment, for example, but not by way of limitation, the sensitivity adjusting section that performs functions of the invention can be a separate general purpose computer containing a set of instructions for performing the functions.

### Third Embodiment

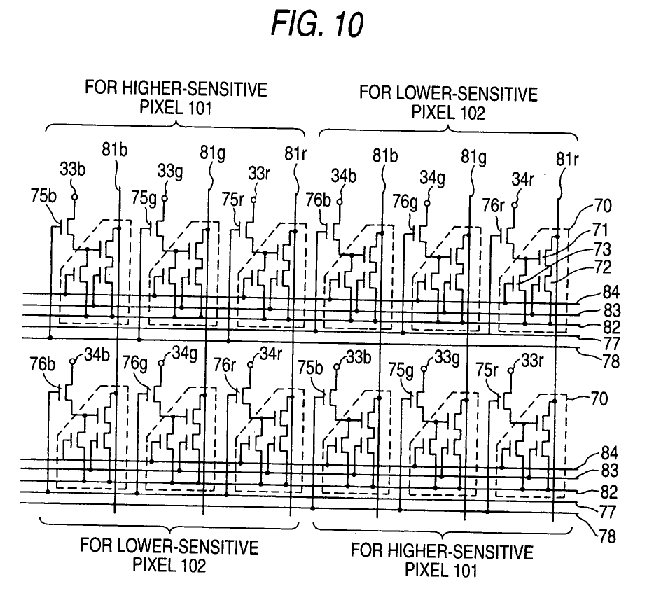

FIG. 10 is a circuit diagram of signal read circuits of a photoelectric converting film stack type solid-state color image pickup apparatus of a third embodiment of the invention. In the photoelectric converting film stack type solid-state color image pickup apparatuss of the first and second embodiments, the signal read circuits disposed in the semiconductor substrate are configured by charge-coupled elements (the vertical transfer paths and the horizontal transfer path). In the present embodiment, the signal read circuits are configured by MOS transistor circuits.

FIG. 10 shows signal read circuits for two higher-sensitivity pixels×two lower-sensitivity pixels. For each pixel, circuits for respectively reading out blue, green, and red signals are disposed, and hence twelve signal read circuits are disposed in total. The signal read circuits have the same configuration. Therefore, the following description will be made only on one of the signal read circuits, and description of the other signal read circuits is omitted while the same reference numerals are affixed with letters r, g, and b.

A red signal read circuit for each of the lower-sensitivity pixel 102 is configured by a charge detecting cell 70, and a charge reading MOS transistor 76r (75r in the case of the higher-sensitivity pixels). The configuration extending to the signal charge accumulating region 34r which reads out signal charges from the pixel electrode film of the photoelectric converting film, and into which the signal charges are accumulated is identical with that of the first or second embodiment. In the present embodiment, the source of the charge reading MOS transistor 76r is connected to the signal charge accumulating region 34r, and the gate is connected to a lower-sensitivity pixel reading signal line 77 (a higher-sensitivity pixel reading signal line 78). The drain is connected to a gate portion of an output transistor 71 which will be described later.

The charge detecting cell 70 comprises the output transistor 71, a row-selection transistor 72, and a reset transistor 73. The source of the output transistor 71 is connected to a column signal line (output signal line) 81r, the gate is connected to the source of the reset transistor 73, and the drain is connected to the source of the row-selection transistor 72. The drains of the row-selection transistor 72 and the reset transistor 73 are connected to a DC power line 82, the gate of the row-selection transistor 72 is connected to a row-selection signal line 83, and the gate of the reset transistor 73 is connected to a reset signal line 84.

The DC power line 82, the row-selection signal line 83, and the reset signal line 84 are connected to a row-selection scan circuit which is disposed on the semiconductor substrate, and which is not shown, to be controlled thereby. The column signal lines 81r, 81g, 81b are connected to an image signal outputting portion which is similarly not shown, and which outputs color signals supplied from the column signal lines 81r, 81g, 81b, to the outside.

In the thus configured signal read circuit, when signals are to be read out from pixels of a certain row, a row-selection signal designating the row is output from the row-selection scan circuit. Therefore, the row-selection transistors of the row are made conductive. In this state, when the row-selection scan circuit outputs an ON signal to the lower-sensitivity pixel reading signal line 77 of the row, the charge reading transistors 76r, 76g, 76b for the lower-sensitivity pixel 102 are turned on, and accumulated charges of the signal charge accumulating regions 34r, 34g, 34b flow into the gate portions of the output transistors 71. As a result, signals corresponding to the amounts of the color signal charges are output to the column signal lines 81r, 81g, 81b, and then supplied to the image signal outputting portion.

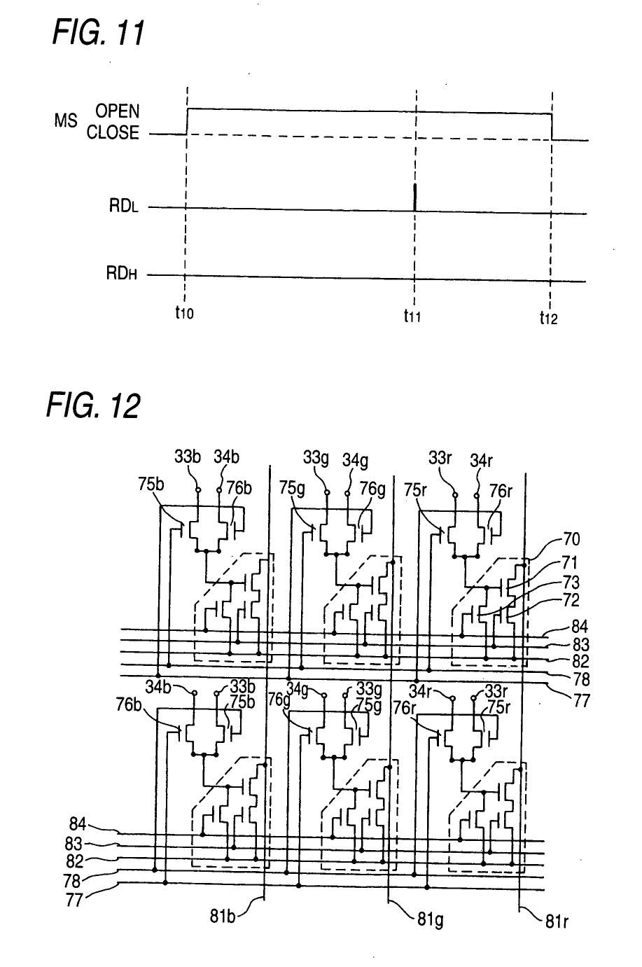

FIG. 11 is a timing chart of an operation which is conducted to adjust the sensitivity in a similar manner as the second embodiment, in the photoelectric converting film stack type solid-state color image pickup apparatus comprising the signal read circuits of FIG. 10.

At intermediate time t₁₁ during a period (t₁₀ to t₁₂) when the mechanical shutter MS is opened, a lower-sensitivity pixel read signal RD_{L} for all the lower-sensitivity pixels 102 is applied to the signal line 77. Therefore, the signal charges of the lower-sensitivity pixels flow into the gate portions of the output transistors 71, and the charges of the signal charge accumulating regions are reduced to zero. The charges flowing into the gate portions of the output transistors 71 are discharged to the DC power line 82, by turning on the reset transistors 73.

After the mechanical shutter MS is closed, the signal charges of the lower-sensitivity pixels 102 and the higher-sensitivity pixels 101 are sequentially read out to the gate portions of the output transistors 71 to be output to the image signal outputting portion.

As a result of the above operation, the sensitivity of the lower-sensitivity pixels 102 is reduced by the factor of (t₁₂−t₁₁)/(t₁₂−t₁₀). Therefore, the sensitivity ratio can be set to a value suitable for an imaging scene. Similarly, the sensitivity of the higher-sensitivity pixels can be reduced by adjusting the timing when a higher-sensitivity pixel read signal RD_{H} for the higher-sensitivity pixels 101 is output to the reading signal line 78.

### Fourth Embodiment

FIG. 12 is a circuit diagram of signal read circuits in a fourth embodiment of the invention. In the third embodiment shown in FIG. 10, signals of the same color are simultaneously read out from the lower-sensitivity pixels 102 and the higher-sensitivity pixels 101 of the same row. In the present embodiment, the signals are separately read out. Namely, the red signal read circuit for the higher-sensitivity pixel 101 in the upper side of FIG. 10, and that for the lower-sensitivity pixel 102 of the same or upper side are commonly configured, a single charge detecting cell 70 is used, and the drains of the charge reading transistor 76r for the lower-sensitivity pixel and the charge reading MOS transistor 75r for the higher-sensitivity pixel are commonly connected to the gate of the output transistor 71.

When a read signal is simultaneously applied to the higher-sensitivity pixel reading signal line 78 and the lower-sensitivity pixel reading signal line 77, therefore, the signal charges simultaneously flow out from the transistors 76r, 75r to the gate of the output transistor 71, and pixel mixture is conducted. When the signal charges are to be separately read out, consequently, the lower-sensitivity pixel read signal and the higher-sensitivity pixel read signal must be non-simultaneously output.

In the embodiment, two reading operations are required for each row, but the number of the column signal lines is reduced to ½ of that in the configuration of FIG. 10, and also the number of the transistors is decreased, thereby producing an advantage that the pixels can be easily miniaturized. The sensitivity ratio of each pixel can be adjusted in the same manner as the control shown in FIG. 11.

In the embodiments described above, each charge detecting cell has a circuit configuration in which the DC power line, the row-selection transistor, the output transistor, and the column signal line are connected in this sequence. Alternatively, the DC power line, the output transistor, and the column signal line may be connected in this sequence.

In the embodiments described above, the higher-sensitivity pixels and the lower-sensitivity pixels are arranged in pixel positions of a checkered pattern, and, even in a state where the higher-sensitivity pixels are saturated, signals of the unsaturated lower-sensitivity pixels can contribute to combined color signals. Therefore, it is possible to take an image of a wide dynamic range.

In the case of (the saturation exposure value of the lower-sensitivity pixels)/(the saturation exposure value of the higher-sensitivity pixels)=4, for example, the dynamic range is widened by about four times. Since color signals of imaginary pixels are interpolated with using correlations between local patterns, an image of a high resolution can be obtained.

In the above, the embodiments in which the invention is applied to a photoelectric converting film stack type solid-state color image pickup apparatus have been exemplarily described. The invention can be similarly applied also to a solid-state color image pickup apparatus in which a plurality of photodiodes are formed in the depth direction of a semiconductor substrate and each of pixels can obtain photoelectric conversion signals of plural colors.

According to the invention, it is possible to obtain a color image of a wide dynamic range, a high quality, and a high resolution.

According to the solid-state color image pickup apparatus of the invention, it is possible to widen the dynamic range. Therefore, the device is particularly useful when mounted on a digital camera.

The entire disclosure of each and every foreign patent application from which the benefit of foreign priority has been claimed in the present application is incorporated herein by reference, as if fully set forth.

1. A solid-state color image pickup apparatus comprising a plurality of pixels,
wherein said plurality of pixels are arranged to form an array pattern comprising a first checkered pattern and a second checkered pattern,
wherein each of said plurality of pixels detects colors signals of red, green, and blue, and
wherein said plurality of pixels comprises: higher-sensitivity pixels forming the first checkered pattern; and lower-sensitivity pixels forming the second checkered pattern.

2. A solid-state color image pickup apparatus according to claim 1,
wherein the higher-sensitivity pixels have larger areas and the lower-sensitivity pixels have smaller areas.

3. A solid-state color image pickup apparatus according to claim 1,
wherein each of the higher-sensitivity pixels comprises microlense, and each of lower-sensitivity pixels comprises no microlense.

4. A solid-state color image pickup apparatus according to claim 1, further comprising:
a semiconductor substrate including signal read circuits;
photoelectric converting films stacked above the semiconductor substrate, the photoelectric converting films comprising a photoelectric converting film for detecting red, a photoelectric converting film for detecting green, a photoelectric converting film for detecting blue; and
a plurality of pixel electrode films each of which is provided at each of the photoelectric converting films so as to define each of said plurality of pixels.

5. A solid-state color image pickup apparatus according to claim 1, further comprising a plurality of light receiving portions each of which corresponds each of said plurality of pixels,
wherein each of said plurality of light receiving portions a photodiode for detecting red, a photodiode for detecting green, and a photodiode for detecting blue in a depth direction of the semiconductor substrate.

6. A digital camera comprising a solid-state color image pickup apparatus according to claim 1.

7. A digital camera according to claim 6, further comprising:
a image signal processing section that performs: interpolating higher-sensitivity color signals which are output from the higher-sensitivity pixels of the solid-state color image pickup apparatus, to produce higher-sensitivity imaginary pixel color signals at imaginary pixel positions of the higher-sensitivity pixels; interpolating lower-sensitivity color signals which are output from the lower-sensitivity pixels, to produce lower-sensitivity imaginary pixel color signals at imaginary pixel positions of the lower-sensitivity pixels; and combining the higher-sensitivity imaginary pixel color signals with the lower-sensitivity imaginary pixel color signals to produce a color image signal.

8. A digital camera according to claim 6, further comprising:
a mechanical shutter; and
a sensitivity adjusting section that performs: discharging first signal charges which are accumulated as a result of photoelectric conversion in the lower-sensitivity pixels at a first timing during a period when the mechanical shutter is opened; and reading out, as signals of the lower-sensitivity pixels, signals corresponding to second signal charges which are accumulated as a result of photoelectric conversion in the lower-sensitivity pixels during a period from the first timing to a second timing when the mechanical shutter is closed.

9. A digital camera according to claim 6, further comprising:
a mechanical shutter; and
a sensitivity adjusting section that performs: discharging first signal charges which are accumulated as a result of photoelectric conversion in the higher-sensitivity pixels at a first timing during a period when the mechanical shutter is opened; and reading out, as signals of the higher-sensitivity pixels, signals corresponding to second signal charges which are accumulated as a result of photoelectric conversion in the higher-sensitivity pixels during a period from the first timing to a second timing when the mechanical shutter is closed.

10. A digital camera according to claim 6, further comprising:
image signal processing means for performing: interpolating higher-sensitivity color signals which are output from the higher-sensitivity pixels of the solid-state color image pickup apparatus, to produce higher-sensitivity imaginary pixel color signals at imaginary pixel positions of the higher-sensitivity pixels; interpolating lower-sensitivity color signals which are output from the lower-sensitivity pixels, to produce lower-sensitivity imaginary pixel color signals at imaginary pixel positions of the lower-sensitivity pixels; and combining the higher-sensitivity imaginary pixel color signals with the lower-sensitivity imaginary pixel color signals to produce a color image signal.

11. A digital camera according to claim 6, further comprising:
a mechanical shutter; and
sensitivity adjusting means for performing: discharging first signal charges which are accumulated as a result of photoelectric conversion in the lower-sensitivity pixels at a first timing during a period when the mechanical shutter is opened; and reading out, as signals of the lower-sensitivity pixels, signals corresponding to second signal charges which are accumulated as a result of photoelectric conversion in the lower-sensitivity pixels during a period from the first timing to a second timing when the mechanical shutter is closed.

12. A digital camera according to claim 6, further comprising:
a mechanical shutter; and
sensitivity adjusting means for performing: discharging first signal charges which are accumulated as a result of photoelectric conversion in the higher-sensitivity pixels at a first timing during a period when the mechanical shutter is opened; and reading out, as signals of the higher-sensitivity pixels, signals corresponding to second signal charges which are accumulated as a result of photoelectric conversion in the higher-sensitivity pixels during a period from the first timing to a second timing when the mechanical shutter is closed.
